(19) United States
(12) Patent Application Publication
(10) Pub. No.: US 2003/0088650 A1
(43) Pub. Date: May 8, 2003

(54) Using a diskless client network topology for disk duplication and configuration

(75) Inventors: Richard C. Fassold, Endicott, NY (US); Michael A. Mele, Endicott, NY (US); Martin B. Patchett, Endwell, NY (US)

Correspondence Address: PERKINS, SMITH & COHEN LLP, ONE BEACON STREET, 30TH FLOOR, BOSTON, MA, 02108, US

(73) Assignee: Lockheed Martin Corporation

(21) Appl. No.: 10/114,501

(22) Filed: Apr. 2, 2002

Related U.S. Application Data
(60) Provisional application No. 60/308,747, filed on Jul. 30, 2001.

(51) Int. Cl. G06F 15/177

(52) U.S. Cl. 709/220

(57) ABSTRACT

A system and method for cloning files to a plurality of client systems simultaneously over a network. Client PCs are booted to a server as “diskless clients”. Each client then executes configuration scripts that prepare mass storage devices to which the clients are connected for downloading a file or files from the server. Any type of file, including an operating system file or applications code, can be downloaded to the mass storage device. The mass storage device can be rendered bootable, should that be an appropriate action for the files that are downloaded. Configuration and log files are stored on the server for each cloned client.

### CROSS REFERENCE TO RELATED APPLICATIONS

The present application claims priority to U.S. Provisional Patent Application No. 60/308,747 filed JULY 30, 2001, entitled USING A DISKLESS CLIENT NETWORK TOPOLOGY FOR DISK DUPLICATION AND CONFIGURATION which is incorporated herein by reference.

### BACKGROUND OF THE INVENTION

This invention relates generally to networked client system creation and maintenance and, more particularly, an improvement to diskless client technology that enables network-based client system disk partial or total reconfiguration.

In a manufacturing environment, the duplication and configuration of hard disks is a labor intensive task. Data processing systems that use multiple identical standalone processor hosts require the same software load or hard drive image in each machine. Manual cloning of operating systems is prone to errors. Setting up numerous virtually identical computer systems is itself a tedious, repetitive task that can drain staff, time, and financial resources. In the case of an operating system in which a hard drive is divided into partitions, a single erroneous entry in a hard drive partition entry screen can wreak havoc with disk drive memory allocation and may result in insufficient memory resources for crucial file systems. When hard drives require physical movement for reconfiguration, they are subject to any number of disabling possibilities. During cloning, each menu selection is open to repeated error by the same employee and extensive rework and error checking may be required. A cadre of trained technicians is normally required to clone operating system and application software.

Diskless workstations (clients) that can boot from a network server were designed to overcome deficiencies expected to arise with the maintenance and expense of cloning a large number of hard disk drives. Booting a diskless client system usually requires a floppy disk drive or a bootROM along with a network connection. The cooperative operation of the server and the diskless client, through handshaking defined by certain protocols, configures the diskless client for operational use. Diskless client technology alone, however, does not allow for the cloning of complete systems precisely because there is no support in such a client system for a mass storage device to preserve the cloned system.

There are prior art systems that automate part of the complete cycle of cloning, verifying, and booting the clone. Symantec's GHOST™ system allows the simultaneous replication of a single disk image to multiple remote systems. WINDOWS NT™ and WINDOWS™ 2000 operating systems are supported. Boot disks are created for the purpose of using GHOST™ features remotely, including using bootable hard drives to connect networked clients to a multicast server for downloading. The administrator in the GHOST™ system must choose the disk image file to be installed and begin the transmission. Another product currently available, PowerQuest DEPLOYCENTER™, creates and restores an exact image of a hard disk for WINDOWS™ operating systems through a secure Web interface. ALTIRIS™ RAPIDEPLOY™ creates a disk image file of the source, uploads that image to a folder on the network server. The network server, under the control of RAPIDEPLOY™, downloads the disk image file by multicasting to all previously-operational network targets. Target-specific parameters are specified from the RAPIDEPLOY™ console. The server maintains a set of data files with specific configuration information for each target. It also reports status information to the RAPIDEPLOY™ console of each target PC. None of these systems support UNIX™ system cloning. They only support clients with functional operating systems previously configured on their hard drives.

U.S. Pat. No. 5,758,165 discloses a UNIX™-based server cloning a Windows™ client. In this system, the initial boot is from the Local Area Network (LAN). There are no cooperating server processes disclosed to enable network and file transfer protocols. No master boot record is written to the client disk.

U.S. Pat. No. 5,974,547 discloses a WINDOWS™-based system in which hard disk emulation software enables a client to boot over the network and access files from a server's hard drive as if the client were booting from its local hard drive.

U.S. Pat. Nos. 6,151,674 and 6,175,918B1 disclose a mobile system known as a network computer that must, upon “first activation” be connected to a network in order to start operating. No operating system nor operating system start parameters exist in local storage on the network computer upon first activation. Thus the first action of the network computer is to download the operating system and operating system start parameters that are reserved for the network computer by the server from which the download occurs. There is no description of disk partitioning, disk formatting, nor support for a UNIX™-based operating system.

U.S. Pat. No. 5,842,011 discloses a method for creating a local disk image that is the copy of an image of a remote disk. The generic remote boot procedure of the invention operates within an MS-DOS environment on the client. This system is not built on well-known diskless client protocols.

U.S. Pat. Nos. 6,108,697, 6,144,992, and 5,857,072 disclose systems in which data are copied from server to client. In these systems, the server's role is to transfer data to an already fully-functional client as if the two hosts were peers.

U.S. Pat. No. 6,128,734 discloses a system in which an alternate bootable mass storage device can be created while the primary bootable mass storage device is operational. After the alternate device is created, the system boot code is modified to boot to the new device. There is no provision for configuring a system with a single mass storage device.

U.S. Pat. No. 6,080,207 discloses a system in which a customized disk image is built according to the user specifications. The disk image is copied to a storage device using known means such as an image server coupled to a hard drive via an interface, or an image server coupled to a disk dupper via an interface.

What is needed is a system and method that allow a manufacturing operation to populate and configure a plurality of systems simultaneously over a network without exhaustion of IP addresses and without any dependencies on format or current configuration of the client's hard disk. Software installation over a Fast Ethernet LAN using inexpensive and Commercial Off the Shelf (COTS) software and equipment could be supported in such a system, which could optimally partition individual client mass storage devices of unknown size, unknown manufacture, and unknown architecture, through a LAN. The result of the operation of such a system could be the installation, on each of the initially non-functional clients, of a complete and functional operating system and, optimally, a complete and functional application system. In support of a fully functional manufacturing environment, the system could provide for automatic file system error checking, and automatic status tracking of each client as it is being configured.

### BRIEF SUMMARY OF THE INVENTION

The problems set forth above as well as further and other problems are solved by the present invention. The solutions and advantages of the present invention are achieved by the illustrative embodiment of the invention described hereinbelow.

Given an existing diskless client system, the present invention includes a system and method for file cloning that could include complete reconfiguration of the client's hard drive to the cloning server's specifications. Major aspects of the present invention include: (a) diskless client technology is used to boot a plurality of clients and configure them for downloading pre-stored files from the server to a mass storage device connected to the client; (b) the server is configured to download files to diskless clients asynchronously, to assign IP addresses dynamically, and to manage limited lease IP addresses; (c) the progress of the cloning activity is monitored on the diskless client and logged to the server; (d) specialized software partitions the mass storage device, regardless of its type and size, under the control of the client.

The client system of the present invention includes a bootROM means, a network connection, and at least one mass storage device. The client is initially unconfigured, and its mass storage device is assumed to be unformatted and not operational. The client begins operation as a diskless workstation. Then, according to command sequences of the present invention, the mass storage device is partitioned. Then files, including perhaps operating system and application software files, are downloaded from the server and installed on the client's mass storage device, and, if applicable, the device is made bootable.

The server system of the present invention includes a network connection, mass storage, diskless workstation support, support for dynamic allocation and limited lease of network addresses, file system download support, and client status tracking support. The server initially performs its part of configuring a client as a diskless workstation as in the prior art. Then, according to command sequences of the present invention, the mass storage device is prepared, for example partitioned, the server transfers files, which could include a client operating system and application software, to requesting diskless clients. The server tracks, on a per-client basis, the progress of the transfer and installation of the transferred files onto the diskless client's mass storage device.

A summary of the system of the present invention follows. Given a system including a network upon which a server and diskless client cooperatively operate, the present invention enables the diskless client to download files from a server to a mass storage device. Ultimately, the mass storage device could become the system disk for the diskless client, and the cloning system could clone a complete system. The system of the present invention includes a means for creating a subnet that includes a server and at least one diskless client. A block of IP addresses is available for limited lease dynamic allocation to the diskless clients of this subnet so that file transfer from the server to the diskless client can proceed through prior art protocols over the subnet. The server allows the diskless client access to a certain at least one file by setting, in a communications message from the server to the diskless client, a file access path that establishes to the diskless client the location of the accessible files on the server. The server and the diskless client, after the system is operational, must both be configured to understand the file transfer protocol that enables the diskless client to transfer files from the server to the mass storage device of the diskless client system. As file cloning progresses, the diskless client tracks cloning activity and informs the server of its progress. The server retains records of the client's cloning activity.

A summary of the method of the present invention, wherein at least one file accessible by a server is cloned to a diskless client over a network, follows. First a boot means, perhaps a floppy disk, is created. The boot means boots the diskless client to the network. Next, the server determines the location of files that are to be cloned and configures itself to allow access to those files. The server further configures itself to accept and store cloning progress monitoring information from the diskless client that is gathered as cloning proceeds. Each client that participates in cloning has a separate special area on the server. Next the diskless client is booted using the boot means and the diskless client sets itself up to communicate with the server as a diskless client. The server has been configured, however, to respond to certain types of diskless client requests by returning access pointers to files that will configure the client to clone files from the server to a mass storage device electronically connected to the diskless client. As the diskless client proceeds through its conventional boot procedure, it arrives at special cloning command files that execute in the context of its downloaded kernel image. The special command files manage the movement of files located in a special area on the server to the client's mass storage device. In the most general case, the client mass storage device is of unknown size and type, so the client command files must determine the available space on the mass storage device and partition it before files are moved from the server. After the mass storage device is prepared, the files to be cloned are copied from the server to the client where copying to the mass storage device occurs. The command files executing on the client insure that the progress of the cloning operation is monitored, and results of this monitoring operation are stored on the server. If the desire is to create a bootable mass storage device, cloned files include at least an operating system. In addition, the command files executing on the client automatically configure the mass storage device to properly execute whichever operating system is cloned to it. Proper execution could require, for example, the creation of a certain sized swap file. Also, the command files must write a master boot record to the mass storage device.

The complete method of the present invention, including creation of a diskless client, includes the steps of booting the client from a network boot device, and requesting from the server an IP address. The server responds with an IP address and a pointer to a kernel image. The client configures its network interface device with the received IP address and proceeds to download the kernel image using the pointer previously given to the client by the server. After the download is complete, control is transferred to the kernel image that begins by completing network configuration using parameters that it requests and receives from the server. The client is brought into the network as a diskless client. The kernel image further accesses from the server any files it requires for complete operation. Control in the client is eventually transferred to client-specific command files. It is these files that manage the cloning procedure that the server and client had been previously configured for. Before the files can be cloned, the client must determine the type and size of mass storage device. For a complete system clone, disk partitioning might be required, and this is automatically accomplished by the system of the present invention. After the mass storage device is prepared, a connection is established between the client and the files located on the server that are to be cloned. Then the files are downloaded from the server to the client. Note that any number of files, as many as the mass storage device will hold and as few as one, can be downloaded. The files are stored on the mass storage device that is electrically connected to the client. If an entire system disk is to be cloned, the copied files are operating system and perhaps application code files. The operating system that is cloned is not the executing operating system in the server, although it can be a copy of it. More importantly, the cloned operating system can be any operating system that is supported on the hardware of the computer to which the mass storage device will eventually be connected (which may be the computer to which the device is currently connected but doesn't have to be). After the operating system and optionally applications code are downloaded, a master boot record is written onto the mass storage device to make the device bootable. Optional method steps include verifying that the cloning operation was successful, retaining symbolic links associated with the cloned files, preserving any relationships between the files on the server and files on the client, and preserving access permission and timestamp information associated with the files. Also, if whole directories are copied, the hierarchical nature of the directories needs to be maintained through recursive directory copy. The server maintain records of cloning progress per client. An aspect of the present invention is that all participating clients may clone simultaneously, and do not have to progress at the same rate through the procedure.

For a better understanding of the present invention, reference is made to the accompanying drawings and detailed description and its scope will be pointed out in the appended claims.

### BRIEF DESCRIPTION OF THE SEVERAL VIEWS OF THE DRAWING

FIG. 1A is a schematic diagram of the client/server network of the illustrative embodiment of the system of the present invention;

FIG. 1B is a schematic block diagram of the cloning system of the illustrative embodiment of the present invention;

FIG. 2 is a schematic diagram of the server and client systems of the illustrative embodiment of the present invention;

FIGS. 3A and 3B are message flow diagrams of the network communication exchanges that occur to boot the diskless client and to perform the cloning operation of the illustrative embodiment of the present invention;

FIG. 4 is a schematic diagram of the flow of information between the client and server during the cloning procedure of the illustrative embodiment of the present invention; and

FIG. 5 is a flowchart of the method of the illustrative embodiment of the present invention.

### DETAILED DESCRIPTION OF THE INVENTION

The system and method of the illustrative embodiment of the present invention are wherein described in terms of a Linux Operating System (Linux OS) environment, but can be implemented within any environment in which there is existing support for diskless client technology. The technology of the illustrative embodiment of the present invention is built upon the building blocks of Bootstrap Protocol (BOOTP), Internet Software Consortium (ISC) Dynamic Host Configuration Protocol (DHCP), Trivial File Transfer Protocol (TFTP), and Network File System Version 2 (NFS V.2). BOOTP was an initial solution to the need to supply an IP address to diskless clients and DHCP was introduced over the BOOTP architecture to provide the capability of dynamically assigning and controlling client IP addresses. TFTP was introduced to the diskless client boot procedure to transfer the boot kernel to the client and finally NFS V.2 has been used by the diskless clients to mount the server partitions to provide the clients with working file systems across the network. The enhancements of the present invention can be more clearly understood when viewed with respect to the configuration of a diskless workstation in the context of the BOOTP, DHCP, TFTP, and NFS protocols, details of which are presented below.

BOOTP, defined by Requests for Comment (RFCs) 951 and 1542, is a protocol that enables a diskless client to discover (a) its own IP address, (b) the IP address of a DHCP server that responds to BOOTP requests on a network, and (c) the location of a file to be loaded into the client's memory to boot the client. These parameters enable the client to boot without requiring a hard or floppy disk drive. A BOOTP client procedure is usually part of boot code that is stored in internal ROM on a Network Interface Controller (NIC). Alternatively, the boot code could be implemented within a PC ROM Basic I/O System (BIOS). DHCP must be configured in the server by means of modifications to the /dhcpd/conf file to recognize BOOTP client messages.

DHCP, defined by RFC 1541, is built on and enhances BOOTP. For functionality provided by both BOOTP and DHCP, they can be used interchangeably with identical results. DHCP consists of two main parts: (a) a protocol for delivering client-specific configuration parameters from a DHCP server to a DHCP or BOOTP client, and (b) a mechanism for allocating an IP address to a network client. Additional administrative DHCP server tasks cover the bookkeeping duties of tracking which IP address belongs to which client and monitoring the duration of an IP address lease. The DHCP server identifies the client by hardware or link-layer address of the client network interface device.

In the DHCP protocol, the DHCP/BOOTP client initiates contact with the waiting DHCP server. If a DHCP/BOOTP client does not receive a response from a DHCP server, it is the DHCP/BOOTP client's job to retransmit the client's message as long as necessary to receive a DHCP-authoritative response from a DHCP server. Additionally, DHCP/BOOTP clients are responsible for maintaining client-server transaction details that are tracked by transaction identifiers, which are created and maintained by the DHCP/BOOTP client. DHCP/BOOTP clients transmit messages (datagrams) to User Datagram Protocol (UDP) port 67 on the server and the DHCP server transmits messages to UDP port 68 of the client. To obtain an IP address the DHCP/BOOTP client sends a BOOTPREQUEST message to the DHCP server. The DHCP server replies with a BOOTPREPLY message containing an IP address assigned to the client.

A DHCP server, on Linux operating systems, is configured through /etc/dhcpd.conf and /etc/dhcpd.leases files. One main function of DHCP configuration is to guarantee that the DHCP server won't allocate duplicate IP addresses. The /etc/dhcpd.conf file (server configuration file) contains network information about the parts of the network serviced by this DHCP server. For dynamic IP address allocation, this file contains the range of possible IP addresses that can be assigned by this DHCP server. The server configuration file also contains settings that allow the DHCP server to accept BOOTP messages. The server requires a /etc/dhcpd.leases file (leases file) to record and track IP address leases granted to clients that have requested a network address. The leases file is an ASCII text file maintained by the DHCP server that contains the DHCP server's entire record of the IP addresses pledged to clients.

TFTP, defined by RFC 1350, is a protocol usually used for downloading a diskless client kernel image file from a server. A TFTP client can only read and write files from/to a TFTP server. The TFTP client cannot list directories and doesn't support user authentication. The TFTP server transfers data in 8-bit bytes, either ASCII code or binary (known as octet). Additional modes can be defined by pairs of cooperating hosts.

Any TFTP transfer begins with a request to read or write a file, which also serves to request a network connection between the TFTP client and the TFTP server. If the TFTP server grants the request, the connection is opened and the file is sent in fixed length blocks of 512 bytes. Each data packet contains one block of data, and must be acknowledged by an acknowledgment packet before the next packet can be sent. A data packet of less than 512 bytes signals termination of a transfer. If a packet gets lost in the network, the intended recipient will time out and may retransmit the last packet (which may be data or an acknowledgment), thus causing the sender of the lost packet to retransmit that lost packet.

TFTP is designed to be implemented on top of UDP. Network packets conforming to TFTP have an Internet header, a UDP header, and a TFTP header. TFTP does not specify any of the values in the Internet header, but the source and destination port fields of the DP header are used by TFTP and the length field reflects the size of the TFTP packet. FTP is configured through modifications to the /etc/hosts.allow file and the /etc/inetd.conf file. The /etc/inetd.conf file, when modified, allows TFTP to execute. The /etc/hosts.allow file identifies protected TFTP services that are allowed to the client and the clients that are allowed access to the listed services.

A Remote Procedure Call (RPC) server hosts a set of procedures that clients call by sending an RPC request to the RPC server along with the procedure's parameters. The RPC server calls up the procedure on behalf of the client and returns requested values to the client. Data communicated by the sender is converted into eXternal Data Representation (XDR) format, to be machine independent, and then converted back to the local machine format by the receiver. In the case of a diskless client, NFS V.2 issues an RPC through port 2049 (or a portmapping facility) and the RPC server recognizes this RPC as a request for client access to NFS V.2 server files. In this way, the client can access the server's files as if they were its own local files.

An NFS V.2 server does not need to know the state of the clients that have contacted it, and is expected to respond to the service requests of the clients. An NFS V.2 client is responsible for initiating and maintaining connection with an NFS V.2 server. The client must handle interruptions of service and must reestablish the connection due to time out or breakdown. The NFS V.2 file system model presumes the file system is hierarchical. If the necessary root read and write permissions are granted to the client, the client host can perform all of the manipulations on the NFS V.2 server's files and directories that the server root user is entitled to perform.

Configuration of the NFS V.2 server occurs in the /etc/export, /etc/hosts.allow, and etc/hosts files. The /etc/export file controls the type of access that is allowed to the server's files. Each line in this file defines a directory and the clients allowed access to it. The /etc/hosts.allow file identifies protected NFS V.2 services that are allowed to the client and the clients that are allowed access to the listed services. The /etc/hosts file supplies the server's IP address and the name of the local server. Configuration of mount options available to the NFS V.2 client occurs in the /etc/fstab file.

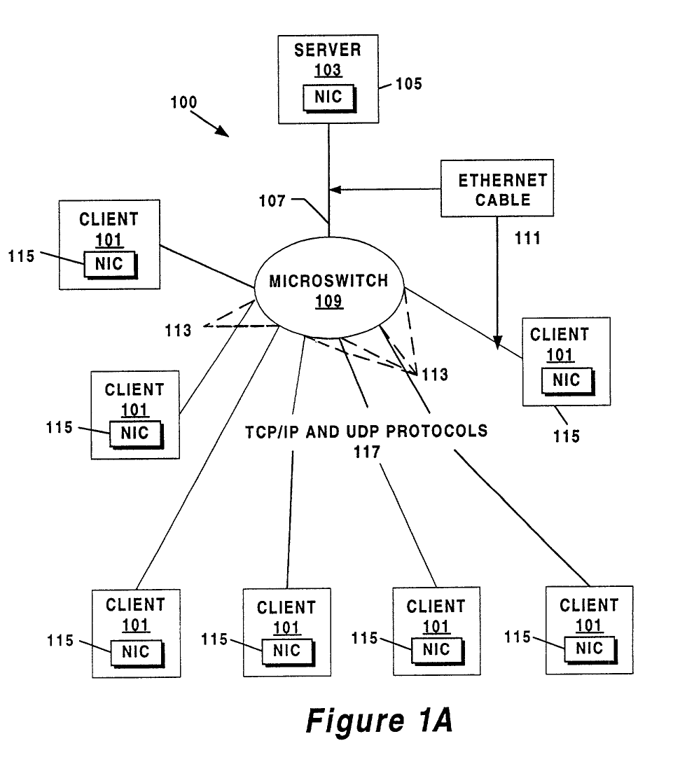

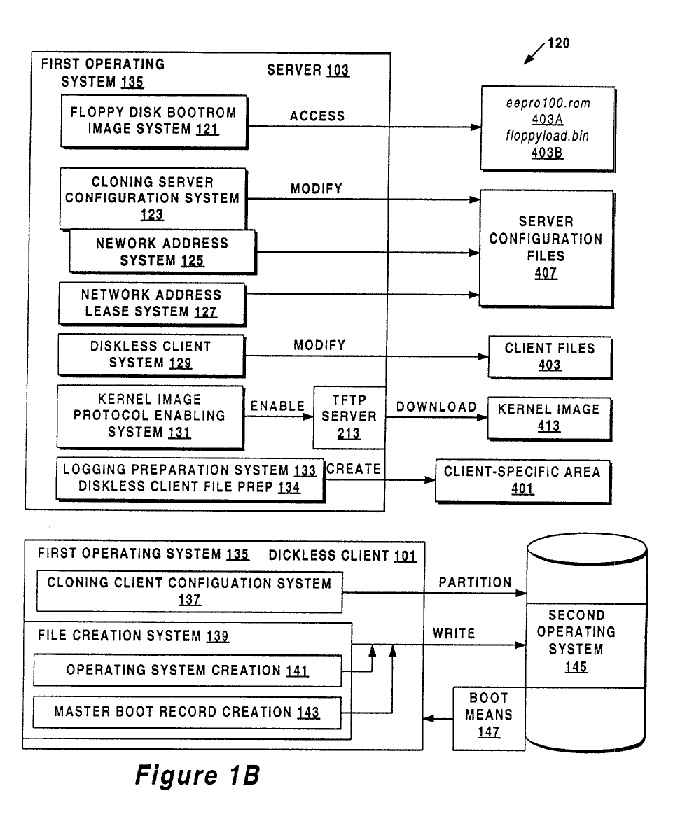

The topology of an illustrative embodiment of network 100 of the present invention, shown in FIG. 1A, includes at least one client 101 and one server 103 communicating for the purpose of automatically cloning a client system mass storage device through network 100. In the illustrative embodiment, network 100 is a 100 Mb full duplex star network that includes a VA LINUX Systems 420 server 103, 7 proprietary clients 101, a CISCO 1548 Micro Switch 10/100 109 with eight fixed ports 107/113, and eight RJ-45 100BaseTX Category 5 Ethernet cables 111. Note that there is no theoretical limit on the number of clients. The hardware configuration presented in FIG. 1A is for illustrative purposes only. Seven clients are presented because of the limitations of the particular Micro Switch in the illustrative embodiment. Each client 101 contains an INTEL eepro100+NIC 115. The server 103 contains an INTEL eepro100+NIC 105 connected to MicroSwitch 109 through port 107. In the illustrative embodiment, network 100 is isolated and is never intended to have contact with any other external network. The system of the illustrative embodiment operates on a 100 Mb packet switched Fast Ethernet LAN. TCP/IP and UDP/IP network protocols 117 manage the handshaking between clients 101 and server 103.

To enable client 101 to boot as a diskless client from server 103, server 103 is preferably prepared as follows: (1) a clean install of the system to be exported to the diskless client is created; (2) client-specific directories on the server are created; (3) a client-specific boot procedure is created; and (4) the server is enabled to export directories, start a DHCP server, and respond to BOOTP requests when the client presents these requests to the server.

Referring now to FIGS. 1B, 2, and 4, a cloning system 120 for cloning at least one file includes server 103 executing a first operating system 135 and a diskless client system 129 for configuring at least one client 101 to operate as a diskless client. In the illustrative embodiment, within server 101, a floppy disk bootROM image system 121 creates a bootROM image on a floppy disk that enables the diskless client to begin a bootstrap procedure from the floppy disk and continue the bootstrap procedure over a communications network that is required for a conventional diskless client. Files eepro100.rom 403A and floppyload.bin 403B are written to a floppy disk to use for booting the diskless client. Although the creation of a floppy disk is specified herein, any conventional means of booting the diskless client can be used. A cloning server configuration system 123 executes that enables the diskless client, through modifications to server configuration files 407, to access from the server at least one file, and that file should have been created in the context of a second operating system 145. Through further modifications to server configuration files 407, a network address system 125 establishes a block of network addresses that are to be dynamically assigned to the diskless client, and a network address lease system 127 establishes a length of time during which each network address in the block of established addresses can be used by the cloning system. A kernel image protocol enabling system 131 enables a TFTP server 213 (described later) to execute on the server 103. A logging preparation system 133 enables the server to receive status messages from the diskless client and stores those messages in client-specific area 401. Further, a diskless client file storage preparation system 134 creates a space for storing at least one file on the server to be later downloaded to the diskless client.

The diskless client, executing in the context of first operating system 135, or possible another operating system, is in electronic communication with a mass storage device 237 where the cloned files reside after the cloning process completes. A cloning client configuration system 137 executed by the diskless client prepares the mass storage device for downloading at least one file from the server to the client's connected mass storage device. The mass storage device 237 is initially unconfigured and inactive, and can be of unknown type and size. The cloning client configuration system 137 includes a file creation system 139 that creates and stores at least one file on the mass storage device 237. Further, the cloning client configuration system 137 includes an operating system creation system 141 for creating and storing a second operating system 145 that is downloaded from the server to the diskless client. The first and second operating systems, 135 and 145 respectively, can be alike or different the cloning client configuration system 137 further includes a master boot record system 143 for writing a master boot record onto mass storage device 237, thus enabling the device to be bootable. A master boot record manages the transfer of control from itself to the second operating system 145 after the master boot record completes its part of booting the now stand-alone client.

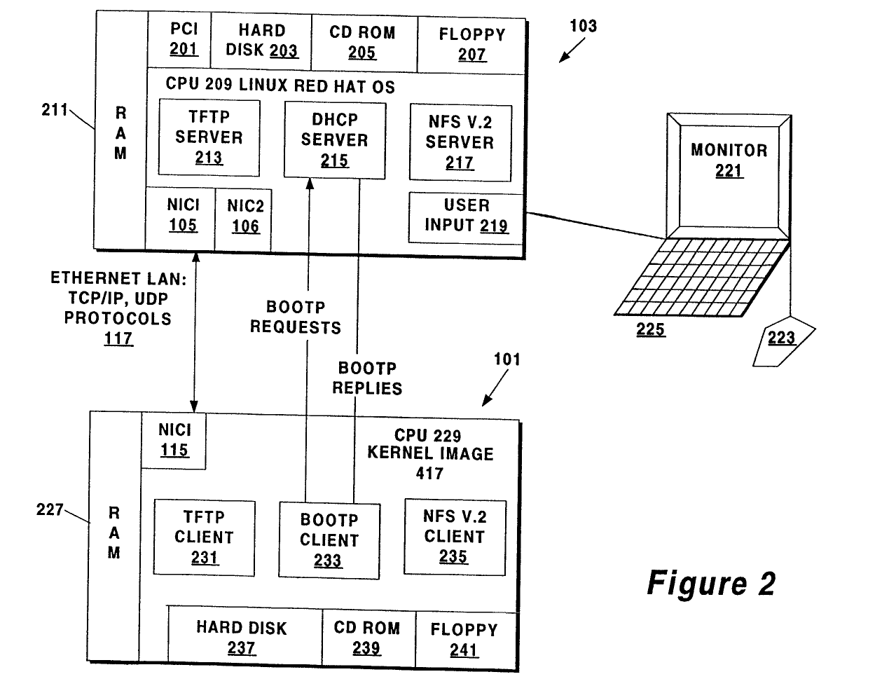

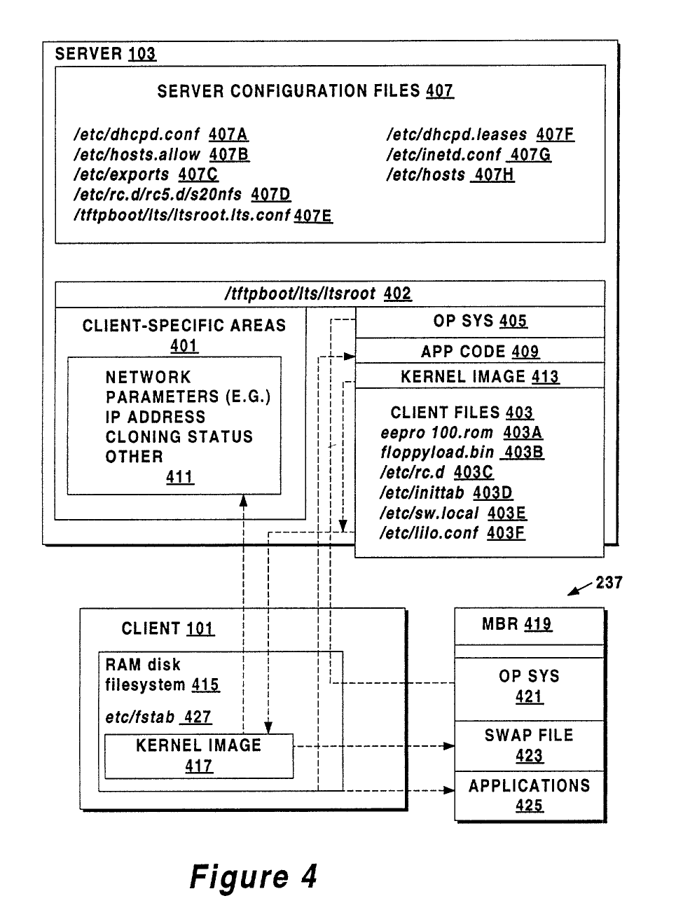

In the illustrative embodiment, the system of the illustrative embodiment executes within a computer hardware context now described with reference to FIGS. 2 and 4. Server 103 includes 256 Mb RAM 211, a 533 Mhz CPU 209, a Personal Computer Interface (PCI) bus 201, two NICs 105/106, a 20 Gb hard disk drive 203, a CD ROM 205, and peripherals such as a floppy disk drive 207, a mouse 223, a keyboard 225, and a monitor 221 connected through user input interface modules 219. The server operating system of the illustrative embodiment is the RedHat 6.1 distribution of the Linux kernel version 2.2.12.

The server 103 of the illustrative embodiment is configured to include a DHCP server 215, a TFTP server 213, and an NFS V.2 server 217. Server 103 includes the capability to create unique storage areas 411 for each client 101 that it serves to record the status of the cloning and other information.

In the illustrative embodiment, server 103 is configured through the /etc/dhcpd.conf file 407A. The /etc/dhcpd.conf file 407A must exist in the correct format on server 103 and must include, in general, (a) complete subnet declarations for all network segments on which the server provides service, (b) an IP address for all possible clients, (c) complete subnet declarations for all network segments to which the server computer's NICs are connected, and (d) a declaration as to whether the server is authoritative for any given subnet declared in the configuration file. Additionally, the DHCP server 215 is configured to dynamically provide a BOOTP client 233 with an IP address for a limited duration through the /etc/dhcpd.leases file 407F. An illustrative /etc/dhcpd.conf file 407A follows:

# Subnet for NIC on the Motherboard
subnet 192.168.1.0 netmask 255.255.255.0

{

| authoritative; | |
|---|---|
| range dynamic-bootp | 192.168.1.1 192.168.1.250; |
| # 192.168.1.251 through 192.168.1.253 reserved for server use | |
| option routers | 192.168.1.254; |
| option subnet-mask | 255.255.255.0; |
| dynamic-bootp-lease-length | 10800; # three hour bootp lease |
| root-path | “tftpboot/kernel”; |

}

# Dummy subnet for second NIC card on the PCI bus

subnet 192.168.2.0 netmask 255.255.255.0

{
}

The declared subnet number of the illustrative embodiment is 192.168.1.0, a private Class C network address chosen so that the illustrative embodiment executes in the context of a private network application. A second network interface NIC2 106 on the DHCP server 215 is defined as a non-DHCP network segment, subnet mask was 255.255.255.0, so as to prevent the DHCP server 215 from interacting with any exterior network that may be attached to the other network devices or NICs on the server 103. The subnet mask informs the DHCP server 215 that the range of IP addresses for the subnet, 198.162.1.0, is from 198.162.1.1 to 198.162.1.250, the router IP address defined to be 198.162.1.254 and the broadcast IP address defined to be 198.162.1.255. IP addresses 198.162.1.251 through 198.162.1.253 are held in reserve for future use. The Class C IP address range provides up to 250 IP addresses.

An authoritative statement is included, but not required, in the /etc/dhcpd.conf file 407A to eliminate DHCP configuration errors received at system boot time. The authoritative statement is designed to verify that the DHCP server 215 is sufficiently authoritative to safely send DHCP acknowledgement messages in response to DHCP request messages. Such authority is not required on the closed BOOTP client-based network of the illustrative embodiment. Since BOOTP does not have the capability to limit the duration of a BOOTP client 233 IP address, the DHCP server 215 must be configured to limit the duration of the lease by setting dynamic-bootp and dynamic-bootp-lease-length parameters. The configuration of he illustrative embodiment includes 3-hour limited lease dynamic allocation of IP addresses to clients 101. To prevent IP address assignment conflicts, the bootpd daemon is not enabled in the /etc/inetd.conf file 407G.

A root-path option provides the diskless BOOTP client 233 a path to mount a network disk from the server 103. The path points to a network kernel image compiled to recognize an Intel eepro100+NIC, Integrated Drive Electronics (IDE) interfaces for CD ROM drives, floppy disk drives, and block devices, and Small Computer Serial Interface (SCSI) block devices.

In the illustrative embodiment, TFTP server 213 is activated in server 103 by removing the leading ‘#’ comment character in the following line in the /etc/inetd.conf file 407G

tftp dgram udp wait root /usr/sbin/tcpd in.tftpd

and rebooting the computer. Also, to allow TFTP clients 231 to function on the 192.168.1.0 subnet, the following line is added to the /etc/hosts.allow file 407B:

in.tftpd: 192.168.1.0

In the illustrative embodiment, the server's NFS V.2 configuration file, /etc/exports 407C, is modified as follows

/tftpboot/Its/Itsroot 192.168.1.0/255.255.255.0(rw,no_root_squash)

to allow all NFS V.2 clients 235 on the 192.168.1.0 subnet to access the server's /tftpboot/Its/Itsroot filesystem. The NFS V.2 client 235 can only access files and sub-directories that reside on the /tftpboot/Its/Itsroot directory 402. The NFS V.2 client 235 has root read/write permission in the /tftpboot/Its/Itsroot directory 402 and its subdirectories. This configuration allows clients 101 to access for execution and/or download the client files 403 located on the /tftpboot/Its/Itsroot directory 402 and to write configuration statistical files back to /tftpboot/Its/Itsroot subdirectories containing files status 411 on the server 103. Another NFS V.2 configuration file, the /etc/hosts.allow file 407B, when modified by adding the following line,

portmap: 192.168.1

allows client 101 to function on the 192.168.1.0 subnet and access through NFS V.2 the server filesystem. The /etc/hosts.allow file 407B identifies those protected services allowed to the client. NFS V.2 configuration file, /etc/hosts 407H, when modified by adding the following line,

192.168.1.1 local.server.host

allows NFS V.2 to resolve the server 103 IP address to a name.

The NFS V.2 configuration file /etc/rc.d/rc5.d/S20nfs 407D, when modified to change the RPCNFSDCOUNT field from the default value of 8 to 16, allows control of up to 16 NFS V.2 threads, which allows a system with 15 clients to execute more efficiently. In a manufacturing environment, each NFS V.2 thread is assigned to a specific client as each incoming request arrives and remains tied to its assigned client as threads are swapped out of the kernel by the scheduler. With only eight default NFS V.2 threads, a thread assigned to a specific client must be reassigned to an unassigned client once the assigned thread goes to a wait state. This assignment switch causes kernel context switching overhead. The 16-daemon configuration allows the server to keep up with the demand of all 15 clients and eliminates server RPC timeouts that delay the NFS file transfer system for all of the clients.

In the illustrative embodiment, the /tftpboot/Its/Itsroot/Its.conf file 407E, which controls how the client RAMdisk kernel image 417 that executes on client 101 behaves during disk cloning, is as follows:

[Default]

| | |
|---|---|
| XSERVER = | XF86_SVGA |
| SERVER = | 192.168.1.254 |
| SYSLOG_HOST = | 192.168.1.254 |
| X_MOUSE_PROTOCOL = | “PS/2” |
| X_MOUSE_DEVICE = | “/dev/psaux” |
| X_MOUSE_RESOLUTION = | 400 |
| X_MOUSE_BUTTONS = | 3 |
| LOCAL_APPS = | Y |
| LOCAL_WM = | Y |
| NIS_DOMAIN = | ltsp |
| NIS_SERVER = | 192.168.1.254 |
| UI_MODE = | SHELL |
| RAMDISK_SIZE = | 4096 |

To enable the server 103 to receive client 101 logging messages during cloning, the SERVER parameter is set to the 192.168.1.254 IP address. When the UI_MODE parameter is set to SHELL, a cloning command sequence is allowed to execute (in the illustrative embodiment, a bash script, i.e. a sophisticated type of UNIX™ command sequence). In the illustrative embodiment, the RAMDISK_SIZE parameter is set to 4096 to specify, in kilobytes, the size of the client RAMdisk filesystem 415, large enough to accommodate the needs of the cloning procedure on the client 101.

Continuing to refer to FIGS. 2 and 4, client 101 contains a NIC 115 embedded on its motherboard, a 1.44 MB floppy disk 241, an IDE CD ROM 239, RAM 227, and an unpartitioned and unformatted 20 GB IDE hard disk 237. In the illustrative embodiment, client 101 must have a floppy disk drive 241 so that floppy disk bootROM code files 403A and 403B can be used (through BOOTP) to provide the client 101 with a unique IP address, but in general, any means of booting that supports diskless operation can be used.

The client 101 and its connected mass storage device are expected to be totally unconfigured and inactive, devoid of an operating system, hard disk partitions, and hard disk filesystems. The BIOS settings of client 101 are configured so that the client boot sequence first probes the mass storage device 237, second the floppy disk 241, third the NIC 115, and finally the CD ROM 239 for bootROM instructions to boot the client. In the illustrative embodiment, the client 101 is booted from the floppy disk 241 with a bootROM image, eepro100.rom 403A created by Etherboot (Open Source under the GNU General Public License Version 2 (GPL2)), along with a floppyload.bin file 403B. An Etherboot ROM image can download code over an Ethernet network. It requires a bootstrap loader, a DHCP server 215 that returns an IP address and other information when sent a MAC address, a TFTP server 213 that sends a kernel image 413 to TFTP client 231 and other files required in the boot procedure, and an NFS server 217 that provides file services to the client through NFS client 235.

The eepro100.rom 403A and floppyload.bin 403B files are stored in client file area 403. To prepare to boot the client 101, the files are moved to floppy disk by the following instruction:

cat floppyload.bin eepro100.rom>/dev/fd0

When the floppy is booted on the client 101, eepro100.rom 403A probes for a NIC 115 assigned to an Ethernet device that is connected to Ethernet cable 111 (referring to FIG. 1), and then continues the boot procedure as if the instruction set came from an eprom on NIC 115. In the illustrative embodiment, there are no special eprom chips required for NIC 115 of client 101.

Later in the client configuration procedure, the NFS V.2 Linux client mount options are configured in the client's /etc/fstab file 427.

Referring to FIGS. 1, 3A, and 4, in the illustrative embodiment, client booting and loading begin as if the client 101 were a diskless workstation of the prior art and herein described as follows. At boot time, the BIOS of client 101 steps through its list of devices assigned to boot the machine. When the BIOS startup sequence arrives at the floppy drive device 241, the eepro100.rom image 403A on the floppy disk finds NIC 115 and creates a diskless workstation as follows. A BOOTPREQUEST on the 192.168.1.0 local network is broadcast (method step 301). The BOOTP broadcast is sent to the DHCP/BOOTP listening port 67 of server 103. The request is addressed to the IP broadcast address 255.255.255.255 and includes the client NIC 115 MAC address. A DHCP server 215 dhcpd daemon, which is listening on server port 67, recognizes the source IP broadcast address 0.0.0.0 as a BOOTPREQUEST and responds to it. The dhcpd daemon reads its /etc/dhcpd.conf file 407A and assigns a temporary IP address to the client 101. The dhcpd daemon may reuse a previously assigned IP address if the NIC hardware address of the request matches a previous assignment or if a lease on the IP address has expired. Server 103 sends a BOOTPREPLY packet to the client 101 that requested the information (method step 303). The BOOTPREPLY packet contains the IP address assigned to the requesting client 101, the 192.168.1.0 local network netmask setting 255.255.255.0, the boot file home directory /tftpboot/Its/Itsroot 402, the client NIC 115 MAC address, and the IP address assigned to the server 103. The BOOTPREPLY packet is broadcast to port 68. When client 101 finds a match to its NIC 115 MAC address in the BOOTPREPLY packet, the client 101 configures the TCP/IP interface in NIC 115 with the client's IP address and the other parameters supplied in the BOOTPREPLY message (method step 325).

When the client NIC 115 has been initialized with its network IP address, the eepro100.rom code 403A issues a TFTP kernel request to port 69 of the server 103 (method step 305). The TFTP kernel request assumes the client's kernel code is contained in or pointed to by the kernel image file 413 on the server 103. When the TFTP server 213 confirms a valid kernel file exists in the /tftpboot/Its/Itsroot directory 402, the kernel image 413, vmlinuz.all supplied by the Linux Terminal Server Project in the illustrative embodiment, is downloaded to the client 101 (method step 307). eepro100.rom code 403A then transfers control to the downloaded kernel 417.

The kernel 417 issues a BOOTPREQUEST to the DHCP server 215 asking for its networking parameters (method step 327). The DHCP server 215 responds with a BOOTPREPLY that contains the IP address assigned to the client 101, the local network subnet netmask setting 255.255.255.0, the server's root directory to be mounted via NFS, /tftpboot/Its/Itsroot 402, the network gateway 192.168.1.254, and the Domain Name Server (DNS) (method step 311). After these items are transferred to the client 101, the client NIC 115 is configured and brought up. Next, the kernel 417 mounts, through NFS, the server 103 filesystem identified in the second BOOTPREPLY to the client 101 (method step 329). This filesystem, in the illustrative embodiment, contains a fully functional copy of the RedHat 6.1 Linux distribution, yet it does not reside in the server's root directory. Note particularly that ANY operating system can be identified in the BOOTPREPLY, and the present invention is not limited to the RedHat Linux distribution, nor to UNIX™. The filesystem contains the directory paths to which clients 101 have been granted read and write access through modifications to the /etc/exports file 407C as described above.

The client configures its network and then requests a mount of the server's filesystem (method step 329) through the server's NFS directory path using NFS (method step 313). The server replies that the NFS mount is allowed (method step 315), and the kernel image mounts the server's NFS directory path (method step 331) and begins its initialization procedure through the server (method step 333). A script residing on the server described in the /etc/inittab file 403D is invoked through NFS (method step 317). This script is responsible for building a library cache, initializing and mounting a swap file, loading some system-specific kernel modules, and setting the hostname. The /etc/inittab file 403D is composed of entries that are position dependent and have the following format: id:runlevel:action.process. Here the id is a two-character unique identifier, runlevel indicates the run level involved, action indicates how the process is to be run, and process is the command to be executed.

When the script finishes, startup is handled by the scripts stored in the /etc/rc.d file 403C on the server and executed on the client (method step 319): init.d, rc, rc.local, rc.sysinit, rcX.d where X=0-6, where rc runs when the runlevel changes, rc.local runs last at startup and can be customized, and rc.sysinit runs once at boot time to load all of the basic modules and start the operating system. The /etc/inittab file 403D controls process dispatching by init.d. Before switching to a runlevel, init.d calls a script described in the /etc/inittab file 403D. When the script completes execution, init.d switches to the specified runlevel. It executes the scripts located in the /etc/rc.d/rcX directory where ‘X’ is the name of the runlevel. In the illustrative embodiment, runlevel 5, representing nameserver and windowing, is invoked from the server and run on the client. These scripts are responsible for starting the portmapper (the RPC service that supplies TCP and UDP port numbers to RPC applications such as NFS V.2) and mounting the NFS-exported /usr,/home and /opt directories. The client 101 also invokes /etc/sw.local 403E (method step 309) which accesses /usr/local and its subdirectories which are used for the installation of software and other files for use on the client 101. /usr/local contains software that is not part of the official distribution, which is usually stored in /usr/bin. At this point, the client is configured as a diskless client. The /etc/sw.local file 403E invokes procedures to partition the client's mass storage device 237 and to install the client's filesystem under the direction of the configuration scripts designed to configure the clients.

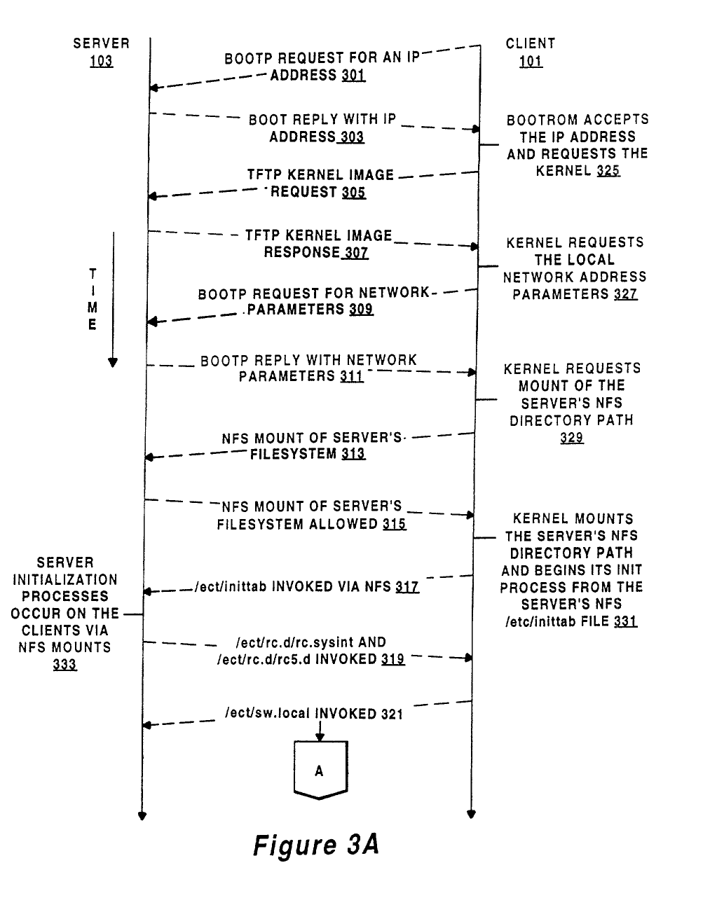

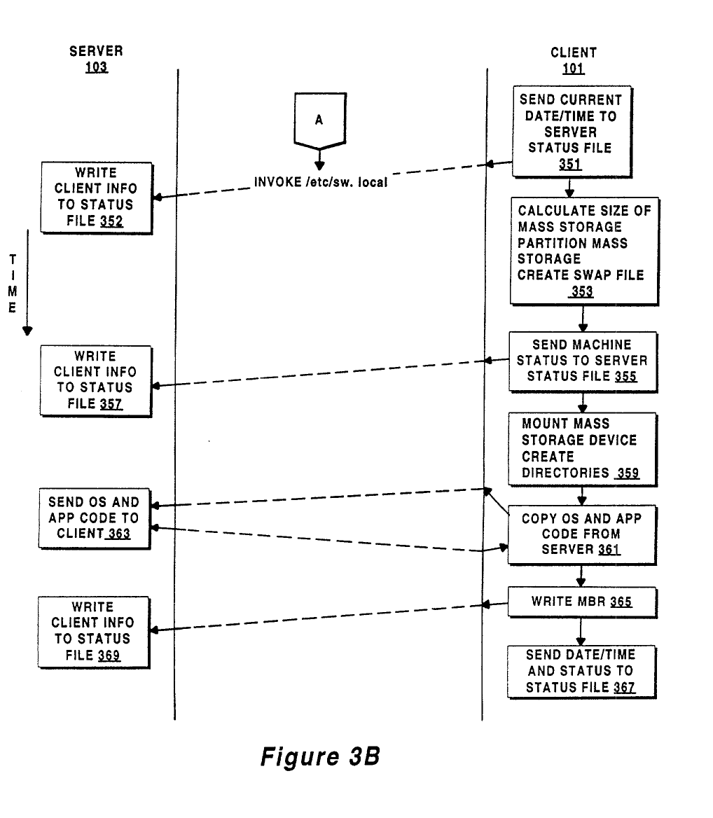

Referring now to FIG. 3B, first, current data and timestamp information are sent from the client to the client status files 411, identified by unique client NIC machine address (method step 351). The server allows the client access to these status files (method step 352). The mass storage device 237 is first prepared for file cloning by determining the type of storage device installed and the amount of mass storage “memory” (i.e. swap file size) available to the client 101 should the user be cloning an entire system disk (method step 353). In the illustrative embodiment, the mass storage device 237 is a hard disk drive, and the dmesg utility is used to detect the hard drive type, IDE or SCSI. The sfdisk utility determines the number of cylinders available on the hard disk 237. This cylinder number is then used to calculate the number of cylinders to be allocated to the /,/boot, swap, and proprietary application partitions.sfdisk, for example, can partition the client's hard drive 237 into the following filesystem types:

| | |
|---|---|
| Partition 1 | Linux second extended (ext2) |
| Partition 2 | Extended |
| Partition 3 | Extended |
| Partition 4 | Extended |
| Partition 5 | Linux ext2 |
| Partition 6 | Linux ext2 |
| Partition 7 | Linux swap or Linux ext2 |
| Partition 8 | Linux swap or Linux ext2 |
| Partition 9 | Linux swap or Linux ext2 |

Note that this partition layout is provided for illustrative use only. Not only can the partitions be organized differently if the cloned client is to be running under the Linux operating system, but mass storage device “partitioning” may be handled in a completely different way depending on the operating system destined to execute on the clone.

Continuing to refer to FIGS. 3B and 4, the mkswap and mke2fs utilities format, in the illustrative embodiment, the Linux swap 423 and Linux second extended (ext2) filesystems. Again the client writes its status information to the server (method step 355), and the server accepts this information (method step 357). Next the client mounts the mass storage device 237 by use of its RAM disk filesystem 415 and creates valid directories on the mass storage device (method step 359). NFS V.2 transfers the operating system 405 and application software 409 from the server 103 to be stored in client's mass storage 237 as cloned operating system 421 and cloned applications code 425, respectively (method steps 361 and 363). This is accomplished by use of the mount, cd, cp, and umount commands to mount the server's NFS directory path filesystem, change directory to the directory address mount point, copy the client directories from the server 103 to the client 101, and to unmount the server directories, respectively. The a option is selected with the cp (copy) command to (a) disable dereference of symbolic links, (b) preserve hard link relationships between source and copy, (c) preserve all owner, group, permissions, and timestamp information, and (d) copy all directories recursively.

Next the client's hard drive 237 is tuned. This is accomplished by the e2fsck command which checks and repairs all of the Linux text2 filesystems created on the client's hard drive 237. Checks on ext2 properties of inodes, blocks, and sizes, directory structure, directory connectivity, reference counts, and group summary information are performed. The status of each ext2 filesystem that was created on the client 101 is reported by the tune2fs command.

Next the client's mass storage bootstrap procedure is configured. In the illustrative embodiment, the Linux lilo boot manager utility is used to read a boot manager configuration file from the /etc/lilo.conf file 403F and to write a boot sector or a Master Boot Record (MBR) 419 on the first sector of the clients' mass storage devices 237 (method step 365). The MBR 419 is used to inform the BIOS of the program to load first in order to start the cloned operating system 421. The MBR 419 enables the Linux kernel to take over the boot procedure from the BIOS. For the last time, status information is written to the server (method step 367) and the server allows the information to be written (method step 369). The procedure is complete.

At this point, the clients 101 are disconnected from the network 100 and possibly booted to their newly-cloned mass storage devices 237. Another set of target clone clients can now be connected to the network in place of the recently-cloned clients 101. Cloning begins again with the loading of the floppy disk into the new set of target clone clients and booting the new set of target clone clients. Note that the clients simultaneously and asynchronously execute the cloning procedure. The possible various states of the clients do not have to be coordinated in any way.

In method steps 351, 357, 363, and 369, client-specific configuration information is stored on server 103 in client-specific area 401. In the illustrative embodiment, the standard output of e2fsck and tune2efs commands is directed to a status file 411 located on the server 103. In addition, at the conclusion of the client mass storage device 237 configuration, the output of the dmesg command is directed to the same status file 411. In the illustrative embodiment, the name of the status file is generated from the NIC 115 MAC address.

In addition to the diskless client described above, and continuing to refer to FIG. 4, the present invention includes a floppy disk that is created containing an Etherboot bootROM using files 403A and 403B. This floppy disk is created in advance of the cloning procedure. Also, server and client configuration files are prepared in advance of the beginning of the cloning procedure. Operating system 405, applications code 409, and kernel image 413 files are generated and stored on the server 103. Client-specific areas 401 are created on the server 103, configuration files 407 are modified as above, and client files 403 are created. The network 100 is cabled, then the client 101 is booted from its floppy disk drive 241 using the previously-created floppy disk. Note that the client could be booted from any possible boot means. In the illustrative embodiment, a floppy disk was chosen so that no special hardware is needed on the clients to be cloned.

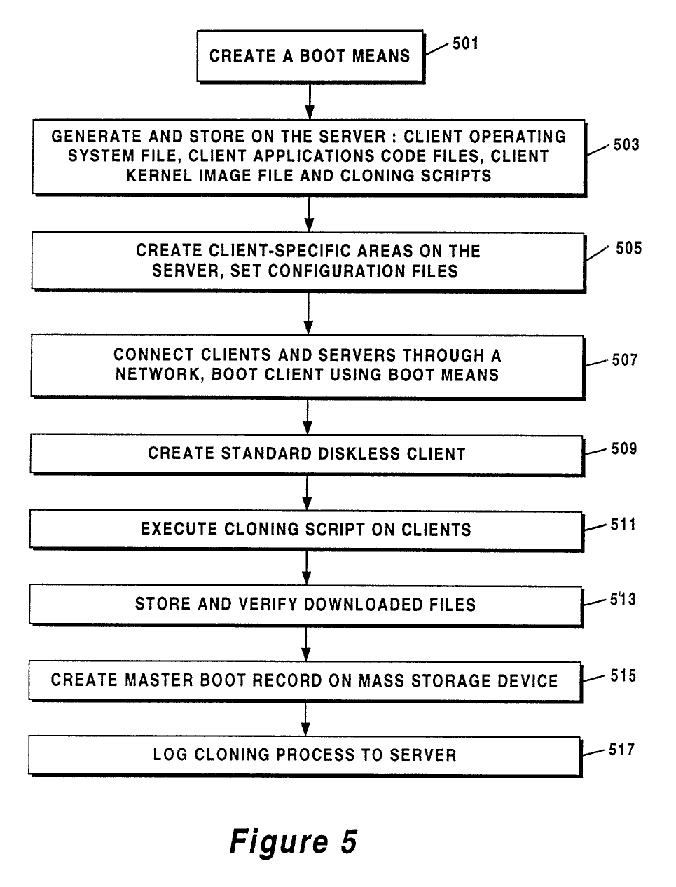

Referring now to FIGS. 4 and 5, a summary of the method of the enhancements of he present invention follows. First a boot means is created (e.g. files 403A and 403B that are stored on a floppy disk) that is used by the client to boot over the network as if it were booting from a network interface (method step 501). Then a client operating system file 405, client applications code files 409, client kernel image file 413, and cloning scripts 403C-E are generated and stored on the server (method step 503). Some of these files will later be downloaded to the client. Client-specific areas 401 including files 411 are created on the server, and configuration is conducted on the system as described above (method step 505). The clients and servers are cabled together with appropriate network devices, then the client is booted using the previously-created boot means (method step 507). A standard diskless client is created (method step 509) and cloning scripts are executed. At this point, the client's mass storage device 237 is partitioned, file systems are created, and the operating system and applications code are downloaded from the server (method step 511). These files are stored on the client's mass storage device, verified, (method step 513) and a master boot record is created and stored on the mass storage device (method step 515). The entire sequence of events is logged to the server during the cloning procedure (method step 517). Clients are disconnected from the network, booted to their newly-cloned mass storage devices (method step 521), and another set of target clones is connected to the network in place of the recently-cloned clients. The procedure begins again.

Although the invention has been described with respect to various embodiments, it should be realized this invention is also capable of a wide variety of further and other embodiments within the spirit and scope of the appended claims. In particular, the system of the present invention can be used to clone parts of mass storage devices, for example just the operating system or just the applications code. An entire mass storage device, as presented in the illustrative embodiment, does not have to be cloned.

What is claimed is:

1. A cloning system for cloning at least one file, said cloning system comprising:
a server executing a first operating system, said server having electronic communication with at least one client through a communications network;
a diskless client system for configuring the at least one client to operate as a diskless client;
a mass storage device being in electronic communication with said diskless client;
a cloning server configuration system executed by said server, said server configuration system enabling said diskless client to access said at least one file, said at least one file created in the context of a second operating system; and
a cloning client configuration system executed by said diskless client, said cloning configuration system preparing said mass storage device for downloading said at least one file, said cloning configuration system downloading said at least one file to said mass storage device.

2. The cloning system as in claim 1 wherein said first operating system is the same as said second operating system.

3. The cloning system as in claim 1 wherein said first operating system is different from said second operating system.

4. The cloning system as in claim 1 wherein said mass storage device is initially unconfigured and inactive, said mass storage device being of unknown type and size.

5. The cloning system as in claim 1 further comprising:
a master boot record system executed by said diskless client, said master boot record system writing said master boot record onto said mass storage device and enabling said mass storage device to be bootable.

6. The cloning system as in claim 1 wherein said server further comprises:
a server network interface to said communications network, said server network interface executing in said server, said server network interface being capable of sending and receiving communications messages;
a DHCP server executing in said server for receiving a network boot request communications message from said diskless client through said server network interface, said DHCP server sending a network boot reply communications message through said server network interface to said diskless client, said DHCP server dynamically assigning a network address to said diskless client;
a TFTP server executing in said server for sending a kernel image communications message through said server network interface to said diskless client after said network boot reply communications message is received by said diskless client;
a NFS server executing in said server for granting access to said diskless client for said at least one file; and
a floppy disk bootROM image system for creating a bootROM image on a floppy disk, said bootROM image enabling said diskless client to begin a bootstrap procedure from the floppy disk and continue the bootstrap procedure over said communications network.

7. The cloning system as in claim 6 wherein the diskless client further comprises:
a client network interface executing in said diskless client for sending and receiving communications messages;
a means for booting said diskless client through said client network interface;
a BOOTP client executing in said diskless client for sending a network boot request communications message from said diskless client through said client network interface to said DHCP server, said DHCP server sending a network boot reply communications message through said client network interface to said diskless client;
a TFTP client executing in said diskless client for receiving a kernel image communications message through said client network interface after said diskless client receives said network boot reply communications message; and
a NFS client executing on said diskless client for accessing said at least one file through said NFS server.

8. The cloning system as in claim 6 wherein said cloning server configuration system comprises:
a network address system for establishing a block of network addresses that are to be dynamically assigned to said diskless client;
a network address lease system for establishing a length of time during which said each network address from said block of network addresses can be used by the cloning system;
a kernel image protocol enabling system for enabling said TFTP server to execute on said server;
a diskless client file storage preparation system for creating a space for storing said at least one file; and
a logging preparation system for enabling said server to receive status messages from said diskless client, said logging system storing said status messages.

9. The cloning system as in claim 1 wherein said cloning client configuration system further comprises:
a file creation system for creating and storing said at least one file.

10. The cloning system as in claim 1 wherein said cloning client configuration system comprises:
a file creation system for creating and storing said at least one file; and
an operating system creation system for creating and storing said second operating system, said second operating system being downloaded from said server to said diskless client, said master boot record transferring control to said second operating system after said master boot record completes its part of a boot procedure of said mass storage device.

11. A cloning system having a network upon which a server and at least one diskless client cooperatively operate, said cloning system enabling the diskless client to clone at least one file initially located on the server, said cloning system comprising:
a subnet creation system for creating a subnet including said server and said at least one diskless client;
an IP address assignment system executing in said server, said assignment system dynamically assigning limited lease Internet Protocol (IP) addresses to said at least one diskless client on said subnet;
a file access path connecting said at least one diskless client to said server through said subnet, said path using said IP address assigned to said at least one diskless client, said path enabling said at least one diskless client to access said at least one file;
a file transfer protocol, said file transfer protocol being understood by said at least one diskless client and said server, said file transfer protocol enabling transfer of said at least one file from said server to said at least one diskless client over said file access path;
at least one mass storage device, said at least one storage device having electronic connection to said at least one diskless client;
a file transfer system for transferring said at least one file from said server to said at least one diskless client over said file access path using said file transfer protocol, said at least one diskless client transferring said at least one file to said at least one mass storage device;
a monitoring system for maintaining a cloning system execution progress log, said monitoring system storing said log on said server.

12. A method for cloning at least one file comprising:
enabling network communications between a diskless client and a server;
accessing the at least one file by said server;
booting the diskless client to said server through said network communications;
creating by the server a network pointer to said at least one file;
accessing said network pointer by said diskless client through said network communications;
creating at least one client-specific area on said server;
configuring said server to allow said diskless client to access said at least one file through said network pointer;
copying said at least one file from said server through said network communications to said diskless client;
copying by said diskless client said at least one file to a mass storage device, said mass storage device having electronic communication with said diskless client; and
creating and populating by said diskless client a copying progress log; and
writing by said diskless client said progress log to said server.

13. The method as in claim 12 further comprising:
copying said at least one file containing a currently non-executing operating system file having separate identity from any operating system currently executing on said server,
copying at least one applications code file;
copying a kernel image file, said kernel image file having code that executes in said diskless client; and
copying at least one cloning command file.

14. The method as in claim 13 further comprising
partitioning said mass storage device;
downloading said currently non-executing operating system file from said server to said diskless client, said diskless client storing said currently non-executing operating system on said mass storage device;
creating a swap file on said mass storage device;
downloading said at least one applications code file from said server to said diskless client, said diskless client storing said at least one applications code file on said mass storage;
verifying that said mass storage device is error-free; and
writing a master boot record onto said mass storage device.

15. A method for cloning at least one file over a communications network,
locating said at least one file on a server, the server having electronic communication with a client, said client having electronic communication with a mass storage device;
configuring the server for cloning said at least one file to said mass storage device through the communications network, the communications network connecting the server and the client;
creating command files, said command files stored on the server, said command files created for execution on the client, said command files enabling cloning of said at least one file;
booting the client from a network boot device,
requesting from the server an IP address,
responding by the server to said requesting step with said IP address and a pointer to a directory on the server, said directory having a kernel image;
configuring by the client a network interface device with said IP address;
requesting by the client a download of said kernel image from the server;
responding by the server with said download of said kernel image to the client;
executing on the client said kernel image;
requesting by the kernel image executing on the client network parameters from the server;
configuring, by the client, network access for the client using said network parameters;
bringing the client into the network;
establishing a connection between the client and at least one file on the server, the client having read and write access to the at least one file;
downloading said at least one file and said command file from the server to the client, the client executing said command file, said command file storing said at least one file on said mass storage device.

16. The method as in claim 15 further comprising:
copying an operating system file having a currently non-executing computer operating system from the server to said mass storage device through the client; and
copying at least one applications code file from the server to said mass storage device through the client.

17. The method as in claim 16 further comprising:
determining, by the client, characteristics of said mass storage device;
partitioning, by the client, said mass storage device according to said characteristics;
downloading said currently non-executing operating system file from the server to the client, the client storing said currently non-executing operating system on said mass storage device;
creating a swap file on said mass storage device;
downloading said at least one applications code file from the server to the client, the client storing said at least one applications code file on said mass storage;
verifying that said mass storage device is error-free; and
writing a master boot record onto said mass storage device.

18. The method as in claim 15 further comprising:
retaining symbolic links associated with said at least one file;
preserving relationships between said at least one file and a copy of said at least one file stored on said mass storage device;
preserving access permission and timestamp information associated with said at least one file, after said at least one file is copied to said mass storage device; and
copying at least one directory recursively to retain a hierarchical directory structure, said at least one directory stored on the server, said at least one directory containing said at least one file.

19. A communication network comprising at least two nodes according to claim 12.

20. Electromagnetic signals traveling over a computer network comprising: said electromagnetic signals carrying information for the practice of the method according to claim 12.

21. A computer readable medium containing instructions for the practice of the method according to claim 12.
